(19) United States
(12) Patent Application Publication
(10) Pub. No.: US 2025/0371049 A1
(43) Pub. Date: Dec. 4, 2025

(54) AI-DRIVEN SYSTEM AND METHOD FOR GENERATING ANSWERS USING AN INTERACTIVE AND DYNAMIC THOUGHT TREE USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventor: Arleif Henry Anthony Braganza, Strathmore (AU)

(73) Assignee: 2hr Learning, Inc., Austin, TX (US)

(21) Appl. No.: 19/218,360

(22) Filed: May 26, 2025

Related U.S. Application Data
(60) Provisional application No. 63/654,017, filed on May 30, 2024.

(51) Int. Cl. G06F 16/3329; G06F 16/332

(52) U.S. Cl. CPC G06F 16/33295; G06F 16/3328

(57) ABSTRACT

An AI-driven system is disclosed for generating a dynamic and interactive thought tree to assist users in resolving complex questions. The system includes a memory storing instructions and one or more processors configured to execute those instructions. Upon receiving an origin question from the user through a user interface, the system prompts an AI engine to decompose the question into a hierarchical structure of system-generated sub-questions. These are displayed in a branching tree format, categorized as intermediary or ultimate sub-questions, depending on whether they lead to further inquiry. The system captures user interactions with the sub-questions and uses them to re-prompt the AI engine, dynamically updating the thought tree in real time. This iterative process continues until the user submits a final input. Based on the completed interaction, the system generates a preliminary output in the form of a response to the original question, offering structured, AI-guided reasoning.

### CROSS-REFERENCE TO RELATED APPLICATION

This application claims the benefit under 35 U.S.C. § 119(e) and 37 C.F.R. § 1.78 of U.S. Provisional Application No. 63/654,017, filed May 30, 2024, which is incorporated by reference in its entirety.

### FIELD OF THE INVENTION

The present disclosure relates to artificial intelligence, decision support systems, and more particularly, to a system and method that leverages AI to help users systematically arrive at decisions.

### BACKGROUND

In the realm of decision support and problem-solving methodologies, traditional tools such as static decision trees, flowcharts, and manually curated prompts have been the standard. While useful in certain contexts, these tools possess significant limitations in terms of adaptability, personalization, and interactivity. Static decision trees and flowcharts are rigid in structure and unable to evolve based on user inputs. This inflexibility restricts users from dynamically exploring various aspects of a problem, leading to a linear and often inadequate problem-solving process. Additionally, manually curated prompts and pre-defined question sets lack to tailor themselves to the unique context of each user's problem, resulting in a less personalized experience.

The advent of artificial intelligence (AI) and machine learning (ML) has introduced new possibilities for enhancing decision support systems. AI-driven technologies, particularly those leveraging natural language processing (NLP) and machine learning algorithms, offer the potential to create more dynamic, context-aware, and responsive tools. However, these AI tools often require iterative refinement, where users must repeatedly input prompts to achieve the desired output. This process can be very time-consuming and may detract from the overall efficiency and user experience, highlighting the need for further innovation in the development of AI-driven decision support systems. Avatars or animated images are digital representations of characters designed to move and interact within a digital environment. The avatars can range from simple 2D images to 3D models and are commonly used in various virtual settings, such as video games, virtual reality experiences, and social media platforms. Typically, the animated avatar is a specific type of avatar that consists of a sequence of still images to create the illusion of movement. The avatars are animated images used to express identities, emotions, and personalities visually and interactively.

The conventional technology for creating interactive avatars had typically relied on real-time rendering of 3D models. Creation of interactive avatars is computationally intensive and often struggles to deliver the desired level of detail or smoothness in animations, particularly when high-definition output is required. Furthermore, the conventional technology had a limitation in scalability and personalization, which constrained the application and effectiveness of the avatars. Historically, animators were involved in manually setting the animation sequence, and computers were used to interpolate the frames to generate the avatar. While this technique has allowed for precise control over the animation, however, it is extremely labor-intensive. Each movement and expression had to be meticulously crafted, which had not only been time-consuming but also lacked spontaneity and fluidity, often making the animations appear stiff and unnatural.

Moreover, the motion capture technique is used which involves recording the movements of a live actor and then applying those movements to the avatar. The motion capture technique produces highly realistic and lifelike animations, however, the motion capture technique requires extensive and expensive equipment. The high costs associated with the motion capture technique made it inaccessible. Additionally, the motion capture had also required considerable post-processing to clean up and refine the captured data, adding to the time and expense. Furthermore, procedural techniques are also utilized in the animation of the avatars. The procedural techniques involve using algorithms to generate movements and behaviors automatically. The animations produced by the procedural techniques are more generic and less personalized, lacking depth and emotional range.

### SUMMARY

The present invention relates to an AI-driven method and system for generating a dynamic and interactive “thought tree” to guide users through complex problem-solving or inquiry processes. Upon receiving an origin user question via a user interface (UI), an AI engine decomposes the question into a hierarchical structure of sub-questions categorized as intermediary or ultimate. These sub-questions are visually presented in a branching tree format, with intermediary sub-questions leading to further questions and ultimate sub-questions terminating the branches.

User interactions with any sub-question are captured and used to re-engage the AI engine, prompting it to refine or expand the thought tree dynamically. This interactive loop continues iteratively, with each user input influencing the evolving structure of the thought tree. Upon user submission, the system generates a preliminary output text that synthesizes the insights gained throughout the interaction and provides an answer to the original question.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary AI-driven system for generating a dynamic and interactive thought three.

FIG. 2 depicts an exemplary artificial intelligence (AI)-driven process for generating a thought tree utilized by the AI-driven system for generating a dynamic and interactive thought tree of FIG. 1.

FIG. 3 depicts an exemplary user interface display according to an embodiment of the AI-driven system of FIG. 1, which allows a user to provide initial input and context to the AI-driven system of FIG. 1 for generating the dynamic and interactive thought tree.

FIG. 4 depicts exemplary process flow diagram outlining the generation of dynamic and interactive thought tree by AI-driven system of FIG. 1.

FIG. 5 depicts a generic representation of an exemplary thought tree structure.

FIG. 6 depicts a screenshot showing another exemplary user interface provided to the user for providing the question and context to the AI-driven system of FIG. 1 for generating the thought tree.

FIG. 7 depicts a thought tree generated based on the user inputs provided in FIG. 6.

FIG. 8 depicts an exemplary screenshot of a portion of a thought tree including a system sub-question with the answer input section.

FIG. 9 depicts exemplary system components involved in the dynamic updating of the thought tree, which is an embodiment of the AI-driven system of FIG. 1.

FIGS. 10-18 are exemplary screenshots showing various nodes and interactive features of the thought tree generated using the process of FIG. 2.

FIG. 19 depicts exemplary a user interface display presented by the AI-driven system of FIG. 1, where the display is showing exemplary output templates for generating a customized thought tree.

FIG. 20 depicts an exemplary user interface display presented by the AI-driven system of FIG. 1, where the display is showing an exemplary template and corresponding preliminary output based on user selection in in FIG. 19.

FIG. 21 depicts an exemplary process flow diagram for generating system sub-questions from an origin user question.

FIG. 22 depicts an exemplary process flow diagram for generating the interactive thought tree as per the AI-driven process of FIG. 2.

FIG. 23 depicts an exemplary process flow diagram for generating a custom template as shown in FIG. 20.

FIG. 24 depicts an exemplary process flow diagram for generating an output thought tree for a chosen template.

FIG. 25 depicts a process flow diagram showing the steps involved in generating the AI-driven interactive and dynamic thought tree, which is an embodiment of the AI-driven process of FIG. 2.

FIG. 26 depicts an exemplary network environment in which the system of FIG. 1 and the process of FIG. 2 may be practiced.

FIG. 27 depicts an exemplary computer system.

### DETAILED DESCRIPTION

An Artificial Intelligence (AI)-driven system and method generate answers to user questions using a thought tree that dynamically and incrementally updates itself for each user interaction therewith. The system and method utilizes a third-party AI engine that leverages advanced Natural Language Programming (NLP) and Machine Learning (ML) algorithms, along with a contextual information database, to process user input in a stage-wise manner and generate corresponding output. Notably, the AI engine is pre-trained on the contextual information database. The contextual information database stores relevant data, background knowledge, and context-specific information, enabling the AI engine to provide more accurate, relevant, and contextually aware answers/responses.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

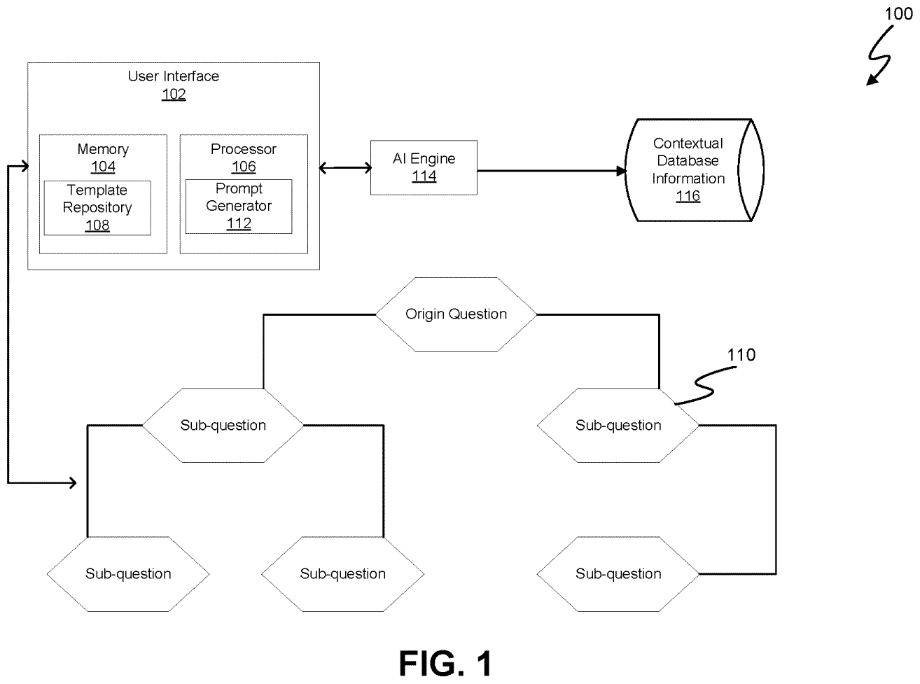

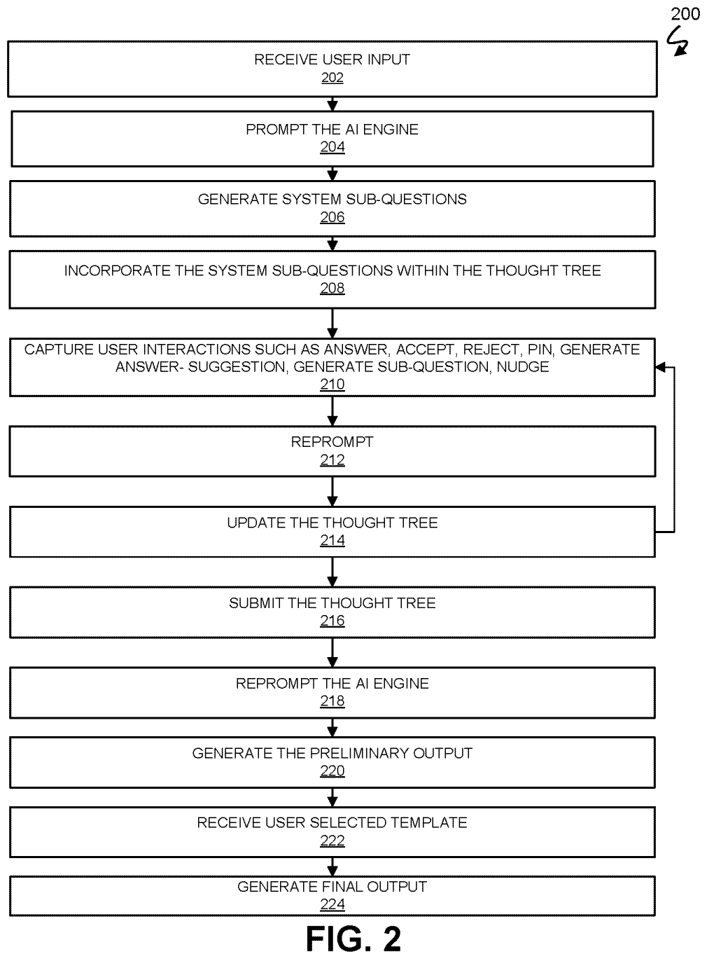

Referring to FIGS. 1 and 2, the system 100 comprises a User Interface (UI) 102 for enabling a user to interact therewith, a memory 104 storing processing instructions and a processor 106 (or processors) that executes said instructions. The UI 102 is accessible via a dedicated application and/or an internet browser, which in turn are accessible through a user terminal such as, a smartphone, laptop, etc., over a communications network, such as the Internet. The memory 104 further comprises a template repository 108, the purpose of which will become apparent from the following body of text. The UI 102, for the most part, comprises the aforementioned interactive thought tree 110. One or more processors 106 execute the steps of the method depicted by the flowchart of FIG. 2. The one or more processors 106 includes a prompt generator 112, the utility of each of which will become apparent from the following body of text. The processor 106 is disposed in operative communication with the aforementioned AI engine 114 that generates an output. The AI engine 114 is in turn disposed in operative communication with the aforementioned contextual information database 116.

Referring to FIGS. 1 and 2, the UI 102 receives the user input, which includes an origin user question. In operation 202, the prompt generator 112 converts the user input into a prompt. In operation 204, the prompt generator 112 prompts the AI engine 114 with the prompt. Notably, the prompt generator 112 generates prompts and thereafter prompts the AI engine with said generated prompts. In operation 206, the AI engine 114 generates system sub-questions in response to the prompt. In operation 208, the system sub-questions are incorporated into an interactive thought tree 110. In operation 210, the processor 106 captures a user interaction performed on the thought tree 110. In operation 212, the prompt generator 112 generates a re-prompt based on said user interaction. In operation 214, the AI engine 114 updates the thought tree in response to the re-prompt. The process loops back to operation 210 and thereafter 212 until user submission, which would be operation 216. In operation 218, the AI engine 114 receives a re-prompt representing said user submission. In operation 220, the AI engine 110 generates a preliminary output upon submission. In operation 222, the UI 102 receives the user selection of a template. In operation 224, the AI engine 110 generates a templated output in accordance with the chosen template. Each of these operations are explained in more detail in subsequent figures.

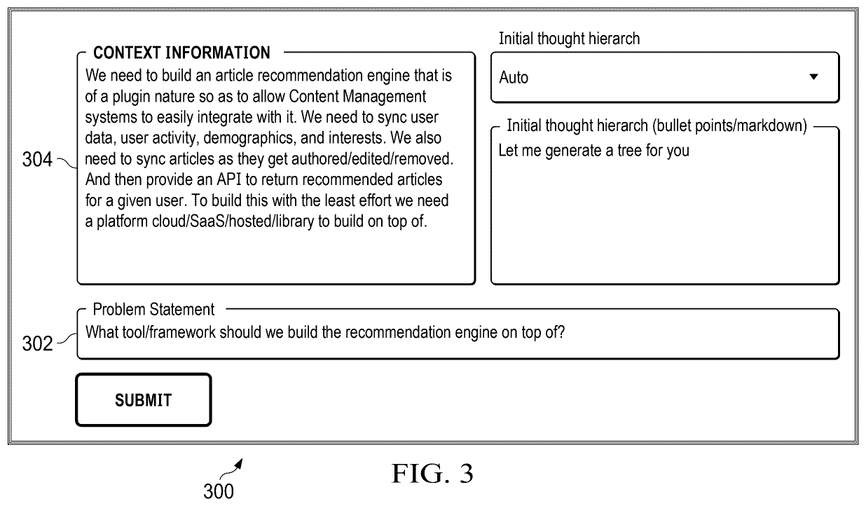

Referring to FIG. 3, an exemplary user interface 300 is designed to receive user inputs for generation of a thought tree. The within a user input includes an origin user question 302 and accompanying context information 304. The context information 304 provides the necessary background and context for the origin question 302. In at least one embodiment, providing the context information 304 is optional for generation of the thought tree.

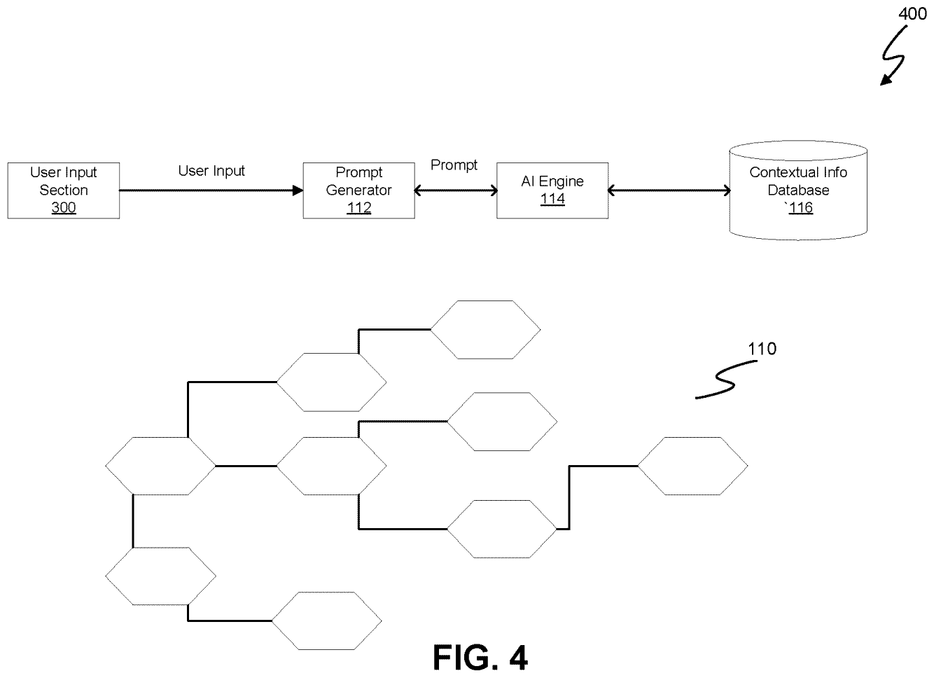

FIG. 4 depicts exemplary process flow diagram outlining the generation of dynamic and interactive thought tree by AI-driven system of FIG. 1. The prompt generator 112 receives the user input from the user input section 300 and turns it into a prompt for the AI engine 114. The processor, by executing the instructions, is adapted to prompt the AI engine 114 with said user input. An exemplary prompt generated by the prompt generator 112 is as follows: “break down the question into multiple sub-questions.” Upon receiving the prompt, the AI engine 114, by leveraging NLP and ML algorithmic techniques, analyses the user input, queries the contextual information database 116, and generates multiple sub-questions for the origin question 302, wherein, a sub-question may in turn be broken down into multiple sub-questions thereof. The sub-questions are referred to as system sub-questions hereinafter. Notably, the NLP algorithms analyze text to understand syntax and semantics whereas, the ML algorithms, on the other hand, are trained on large datasets to predict the most relevant questions based on the context provided by the user. Therefore, both NLP and ML are critical for enabling the AI engine to generate contextually relevant questions, thereby, as will be understood hereinafter, making the thought tree dynamic and responsive to user interactions.

Notably, any suitable language, such as Python, Java, etc., with AI development support is used for generating sub-questions. The relevant public libraries used would be TensorFlow, PyTorch (for ML). The variables and definitions used include problem_statement (the user's initial input), contextual_data (data relevant to the problem domain), generated_questions (questions produced by the AI).

Referring to FIG. 4, the sub-questions generated by the AI engine 114 are incorporated within a thought tree 110, which is akin to a hierarchical branching tree structure that can expand, contract, and evolve as commonly seen in data structures. Notably, the thought tree is also a type of graph where transversal algorithms are applied to navigate it. In one embodiment, the thought tree 110 is generated by the processor.

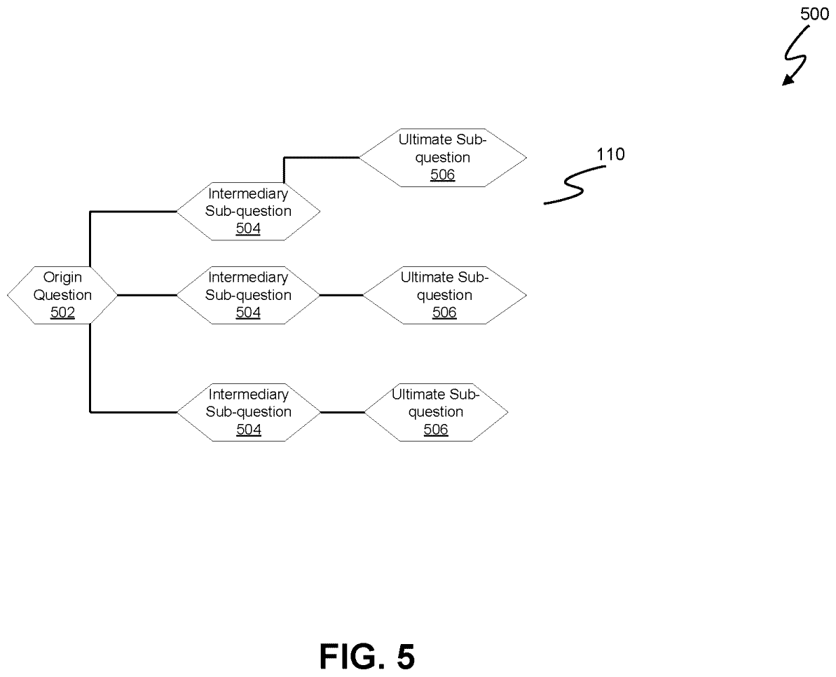

FIG. 5 depicts a generic representation of an exemplary thought tree structure As shown here, within the thought tree 110, the parent node houses the origin question 502, while the other branching nodes house the system sub-questions. The system sub-questions are categorized into intermediary 504 and ultimate 506 system sub-questions. An intermediary system sub-question 504 branches out from either the origin question 502 or another sub-question with subsequent sub-question(s) branching out from said intermediary system sub-question 504. An ultimate system sub-question 506 branches out from either the origin question 502 or another sub-question with no subsequent sub-question(s) branching out from said ultimate system sub-question 506. Notably, an intermediary question 504 is nested within a child node of the thought tree 110, while an ultimate question 506 is nested within a leaf node. Notably, all questions, or the nodes thereof, are user-interactable through the UI. In one embodiment, the AI engine 114 (of FIG. 4) is configured to limit the number of system sub-questions (and thereby the thought tree nodes) to a predetermined threshold number so as not to overwhelm the user. Notably, wherever the term “system sub-question” is mentioned in the following or the preceding body of text or in the accompanying drawings, it could mean either intermediary system sub-question, ultimate system sub-question, or both.

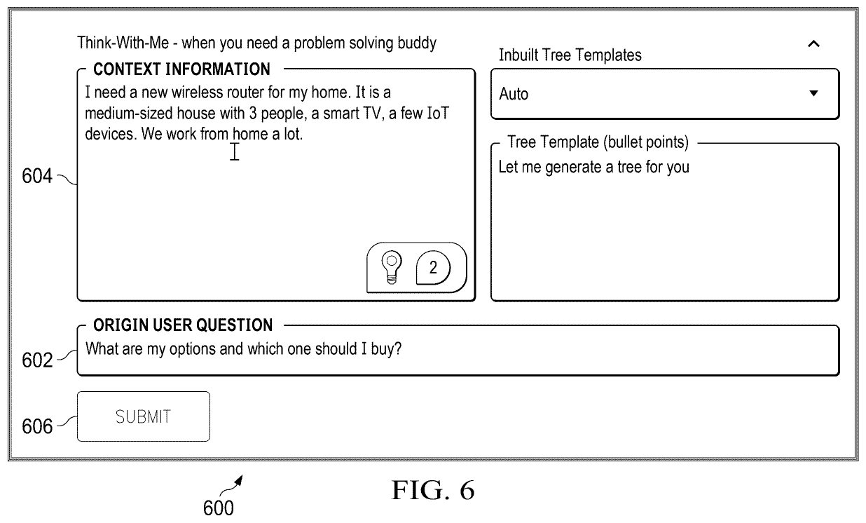

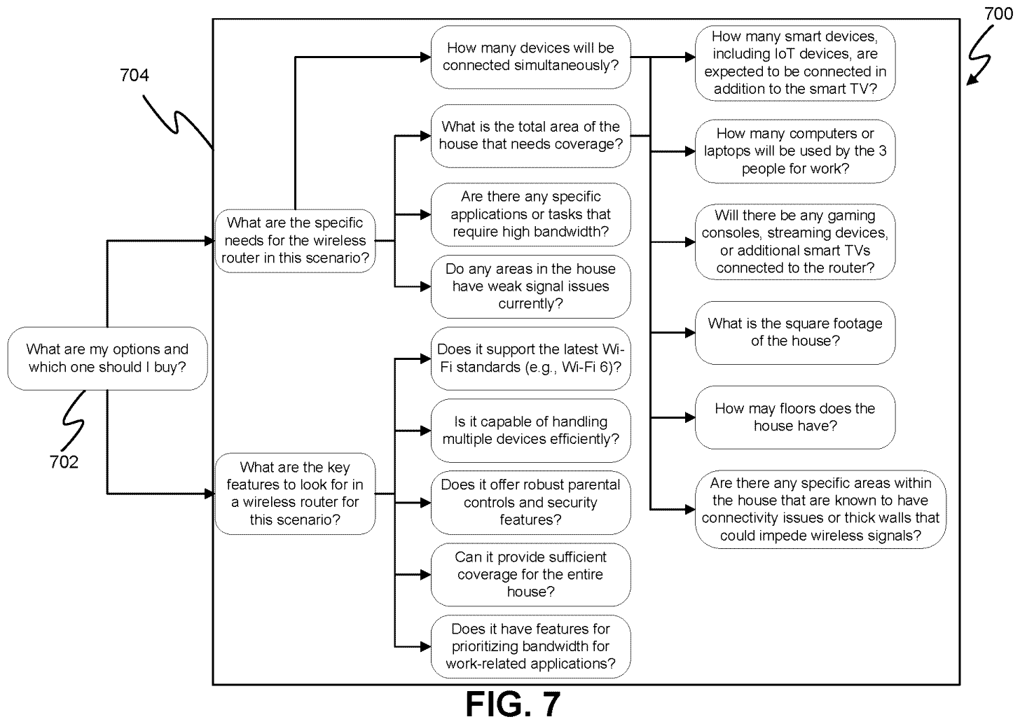

FIGS. 6 and 7 depict exemplary user interface provided to the user to input the problem statement (or question) and the context to generate a through tree corresponding to the contextual inputs. For example, consider a user looking to purchase a Wi-Fi router. The user begins by providing the user input, which includes the origin user question 602 and the context information 604. Upon submitting the user input by clicking the “submit” button 606, a thought tree 700 is generated. This thought tree 700 features the origin question 702 within its parent node and the several intermediary and ultimate system sub-questions 704 featured within the child nodes.

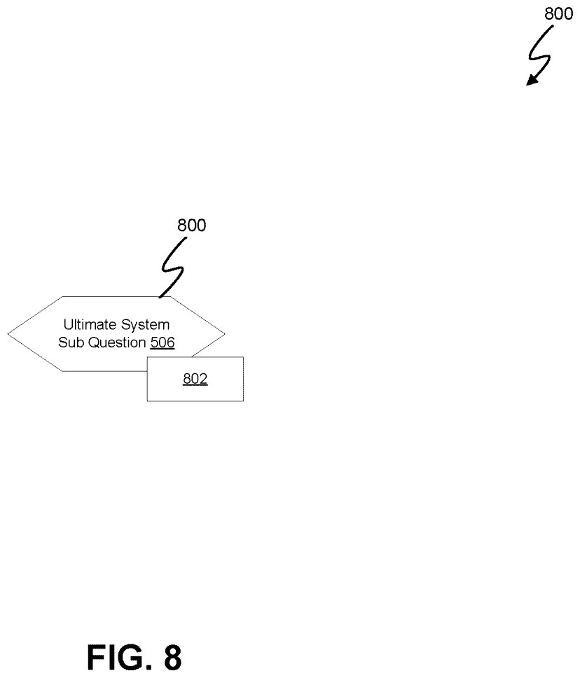

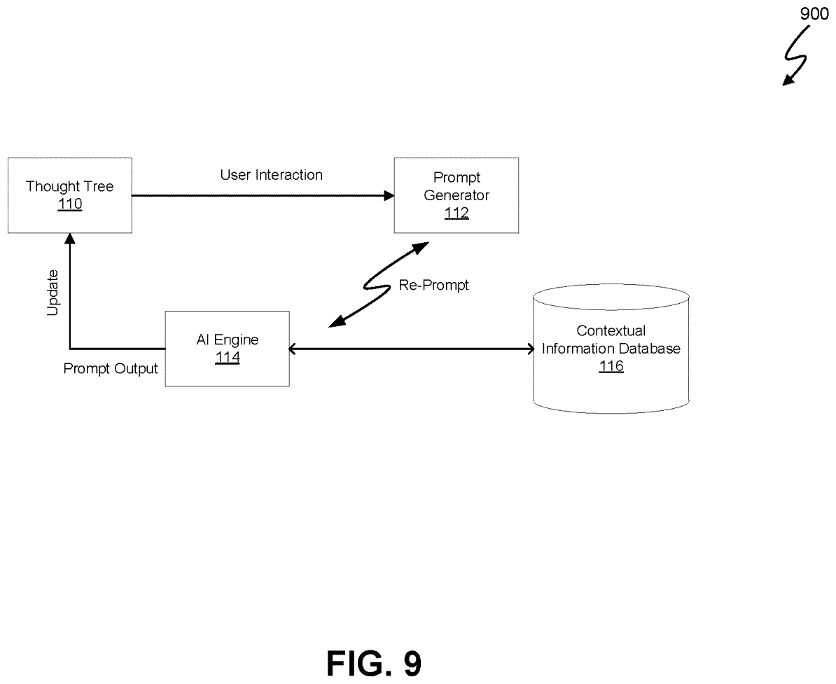

Referring to FIG. 8, each ultimate system sub-question 506 is adapted to receive a user answer thereto within an answer input section 802 of the corresponding leaf node 800. The answer section 802 is launched by selecting an appropriate link associated with said leaf node 800. Referring to FIG. 9, the thought tree 110, upon receiving the answer, which is a user interaction, relays said answer to the prompt generator 112. The prompt generator 112 prompts the AI engine 114 with the answer as a new input re-prompt. The AI engine 114, in response to the new re-prompt, in service of the origin question and in conjunction with the contextual information database 116, is adapted to generate even more system sub-question(s), remove existing system sub-question(s), modify existing system sub-question(s), or a combination thereof. Alternatively, the AI engine 114 may choose to take no action. Thereafter, the AI engine 114 updates the thought tree 110 in accordance with the prompt output thus rendering the thought tree 110 dynamic in nature. In the event of there being no response from the AI engine 114, the thought tree 110 is still updated as the corresponding ultimate system sub-question (or the node thereof) is disabled upon receiving the user answer thereof. In one embodiment, the processor, by executing instructions, is configured to re-enable a disabled node whereby, the user may, inter alia, replace, remove or edit his/her previous user answer.

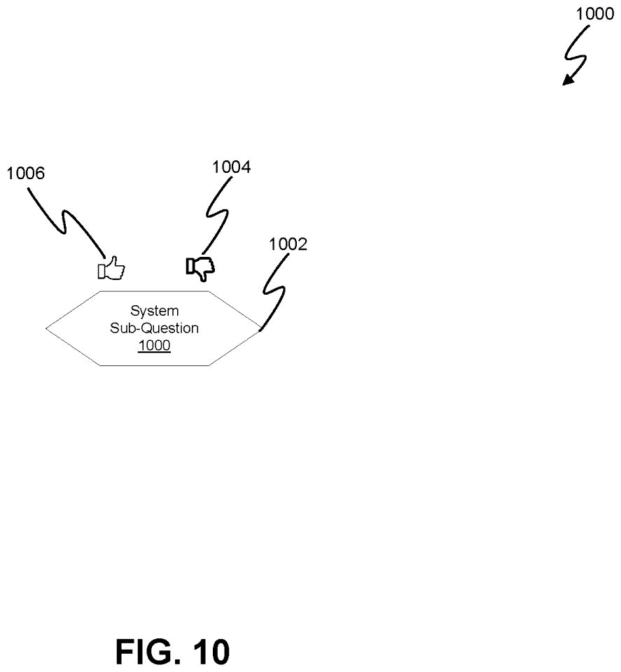

Referring to FIG. 10, a system sub-question 1000 (or the node 1002 thereof) is associated with a user-selectable “dismiss” or a “reject” option (represented by a “thumbs down” button 1004), which when selected, said system sub-question 1000 is dismissed/rejected and the corresponding node 1002 is disabled. Referring back to FIG. 9, this user interaction on the thought tree 110 is then fed by the prompt generator 112 as a new input re-prompt to the AI engine 114. Based on the resulting output from the AI engine 114 updates the thought tree 110 accordingly. This updation may include generation of even more system sub-questions (that, for instance, may have been previously repressed so as to maintain aforementioned threshold number), removal of existing system sub-questions, modification of existing system sub-questions, or a combination thereof. Alternatively, the AI engine 114 may choose to take no action other than the disablement of the sub-question. In the event of the system sub-question being an intermediary sub-question, all the ultimate system sub-questions branching out therefrom are fittingly disabled. On the other hand, in the event of the system sub-question being an ultimate sub-question, then only said sub-question is disabled.

Referring to FIG. 10, a system sub-question 1000 (or the node 1002 thereof) is associated with a user-selectable “accept” option (represented by a “thumbs up” button 1006), which when selected, said system sub-question 1000 is deemed accepted. Referring to FIG. 9, the prompt generator 112, by executing the instructions, is configured to then feed this user interaction as a new input re-prompt to the AI engine 114. Based on the resulting prompt output, the AI engine 114 updates the thought tree 110 accordingly. This updation includes generation of even more system sub-questions branching out from the accepted system sub-question, removing existing system sub-questions, modifying existing system sub-questions, disabling the corresponding sub-questions, or a combination thereof. This renders the accepted system sub-question to be an intermediary system sub-question in the event of said accepted system sub-question being an ultimate system sub-question prior to the acceptance thereof.

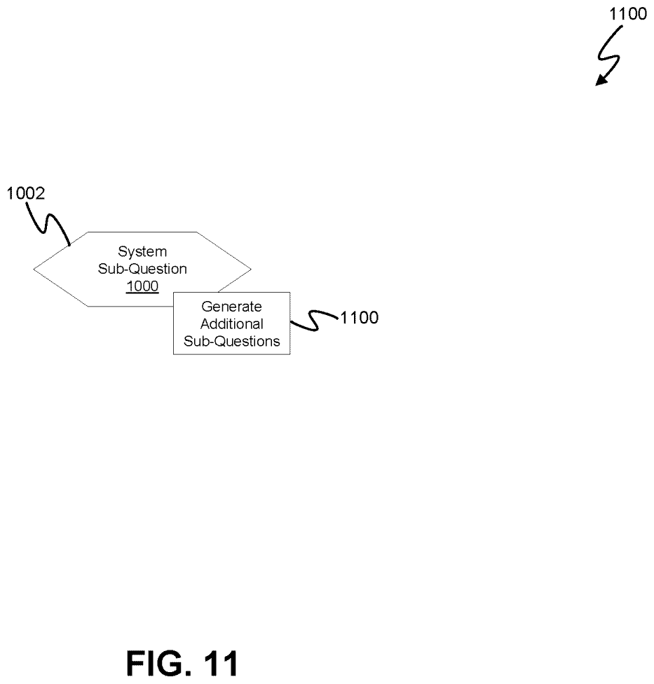

Referring to FIGS. 9 and 11, similar to the “accept” option, a system sub-question 1000 (or the node 1002 thereof) is associated with a user-selectable “generate additional sub-questions” option/link 1100, which when selected, the prompt generator 112, by executing instructions, is configured treat this user interaction as a new input re-prompt and is relayed to the AI engine 114. In response, the AI engine 114 generates new sub-questions for the corresponding system sub-question and the thought tree 110 is updated accordingly. In the event of the corresponding system sub-question being an intermediary sub-question, then the newly generated sub-questions (i.e., the nodes thereof) are rendered as sibling nodes to the existing child nodes thereof. On the other hand, in the event of the corresponding system sub-question being an ultimate sub-question, then by virtue of the generation of new sub-questions therefrom, said ultimate sub-question is converted into an intermediary system sub-question with the newly generated sub-questions (i.e., the nodes thereof) rendered as the child nodes thereto. The AI engine 114 updates the thought tree 900 accordingly.

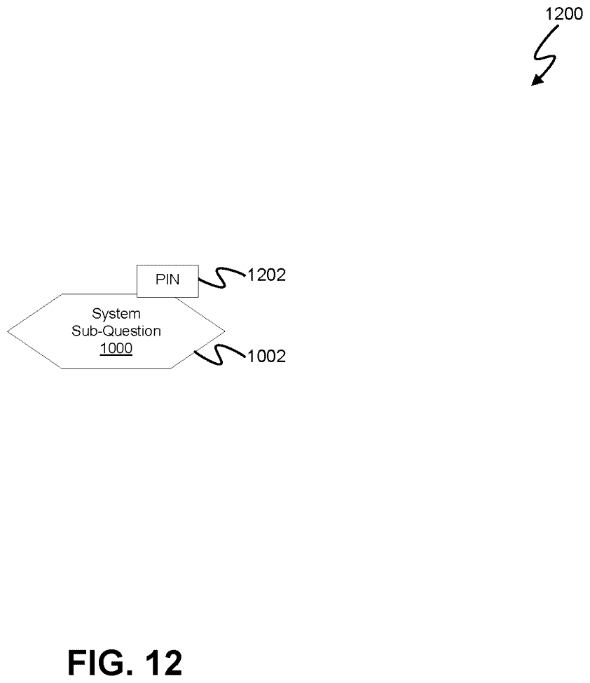

Referring to FIG. 12, a system sub-question 1000 (or the node 1002 thereof) is associated with a user-selectable “pin” or “pin node” option/button 1200, which when selected, said system sub-question 1000 (or the node 1002 thereof) is “pinned” and resultingly is not subjected to change during the course of the continuous evolution of the thought tree. Referring to FIG. 9, pining a node is also, in a way, treated as the aforementioned “acceptance” of the sub-question thereof thereby applying the subsequent “acceptance” processes thereto. The prompt generator 112, by executing the instructions, is configured to then feed this user interaction as a new input re-prompt to the AI engine 114. Based on the resulting re-prompt output, the AI engine 114 updates the thought tree 110 accordingly. This updation may include the generation of even more system sub-questions branching out from the pinned system sub-question.

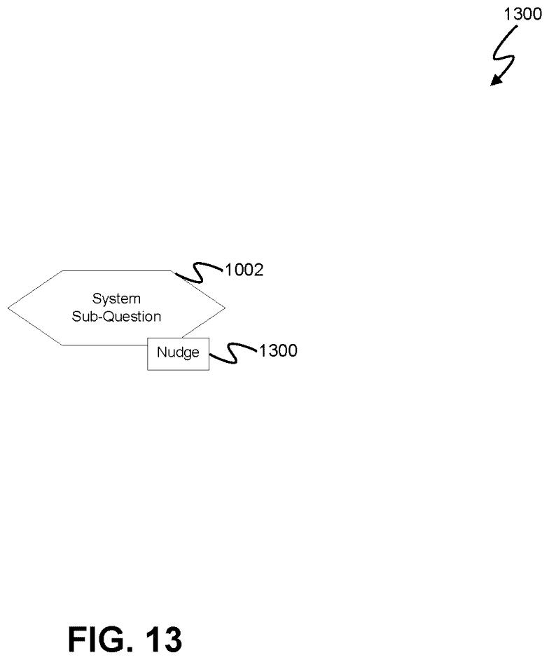

Referring to FIG. 13, a system sub-question 1000 is, via the UI, adapted to receive a “nudge” wherein, a nudge includes a user's textual input. A system sub-question 1000 is simply nudged by selecting an exemplary “nudge” link/button 1300, leading to the launch of a text input field for receiving said textual input. Referring to FIG. 9, the thought tree 110 upon receiving the nudge, the prompt generator 112 is configured to re-prompt the AI engine 114 with the nudge as a new input re-prompt. The AI engine 114, in response to the new input prompt, is adapted to modify the corresponding sub-question and, if applicable, generate additional system sub-questions therefrom, modify existing sub-questions thereof, remove existing sub-questions thereof, or a combination thereof. The AI engine 114 is configured to update the thought tree 110 accordingly.

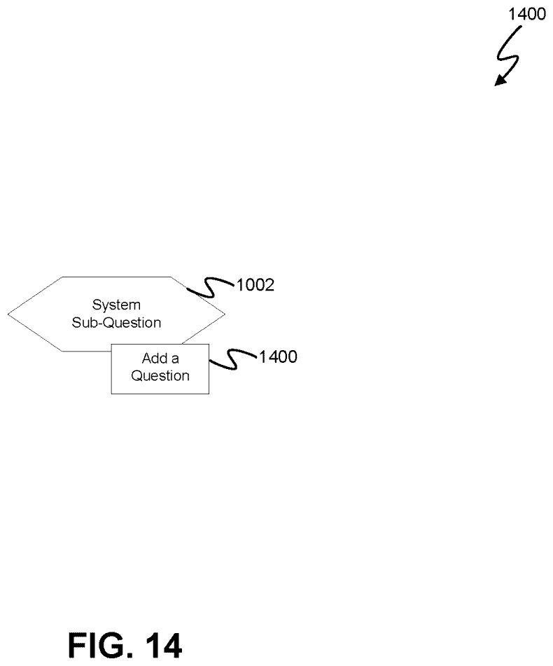

Referring to FIG. 14, the thought tree, via the UI, adapted to receive a new user sub-question by selecting an exemplary “add a question” button/link 1400 associated with a sibling node 1002 wherein, said user sub-question could branch from any system sub-question.

Referring back to FIG. 9, upon receiving the user system sub-question, the prompt generator 112, by executing the instructions, is configured to re-prompt the AI engine 114 with the new user sub-question as a new input re-prompt. Notably, the processor, by executing instructions, is adapted to treat a user sub-question as same as a system sub-question. The AI engine 114, in response to the new input re-prompt, is adapted to generate additional intermediary or ultimate system sub-question(s) therefrom, modify existing sub-questions, remove existing sub-questions, or a combination thereof. In one embodiment, the user is allowed to add a user sub-question to a previous user sub-question. Thereafter, the AI engine 114 updates the thought tree 110 in accordance with the re-prompt output. Notably, wherever the term “sub-question,” “ultimate sub-question,” or “intermediary sub-question” is mentioned in the preceding or the following body of text or in the drawings, it could be either system generated or user added.

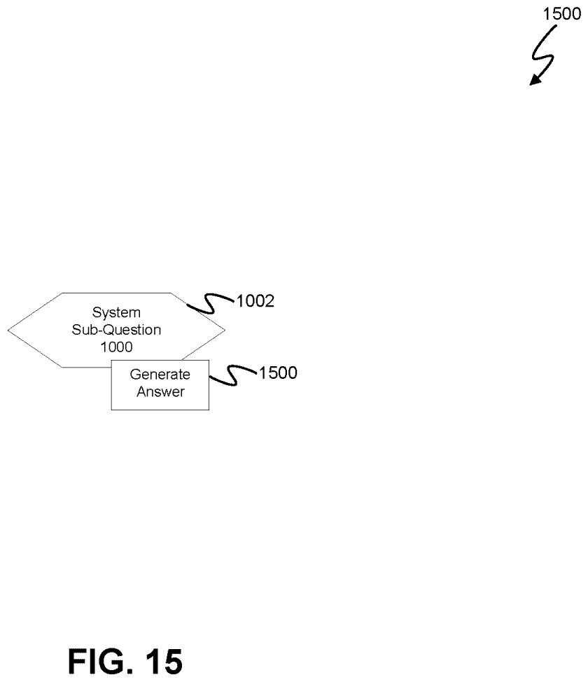

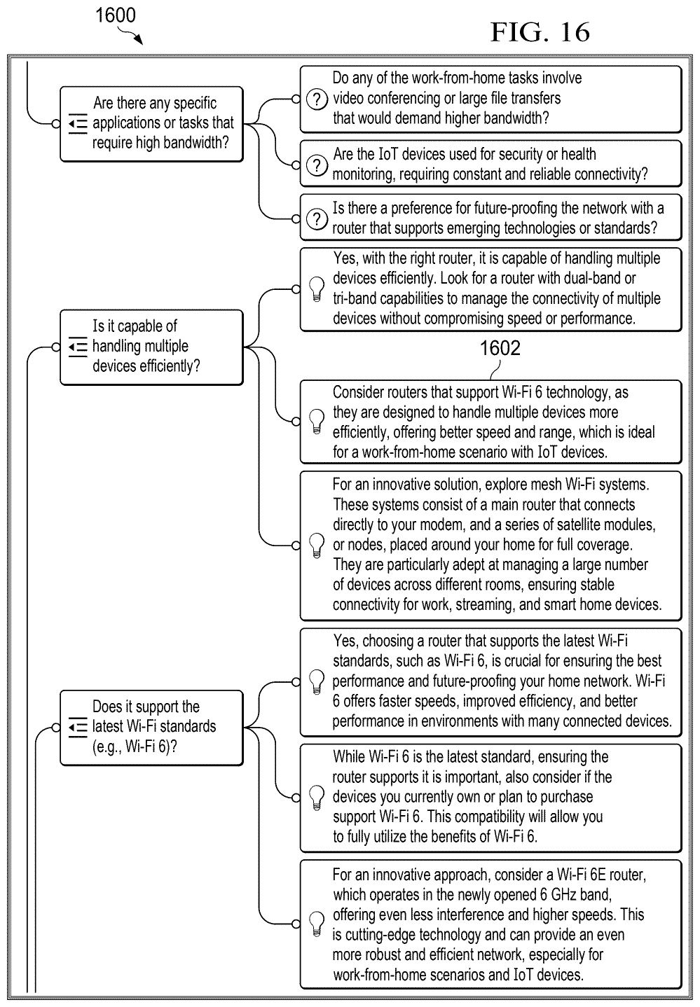

Referring to FIGS. 9 and 15, instead of the user being required to input his/her answer to an ultimate sub-question 1000, the prompt generator 112, upon the user selection of an exemplary “generate answer” link/button 1500, re-prompts the AI engine 114 to generate one or more answers for said sub-question 1000, which could be system or user generated. The one or more answers generated by the AI engine 114 are incorporated into the thought tree 1600 as answer-suggestions 1602 to the corresponding sub-question as seen in FIG. 16. More particularly, an answer-suggestion 1602 is presented within a leaf node branching out from the node of the corresponding sub-question. Notably, an answer-suggestion 1602 is associated with an exemplary bulb icon that serves as an answer-suggestion indication. In one embodiment, instead of selecting a “generate answer” button 1500, the one or more answer-suggestions to a sub-question are automatically generated by the AI engine 114 and accordingly incorporated into the thought tree 110.

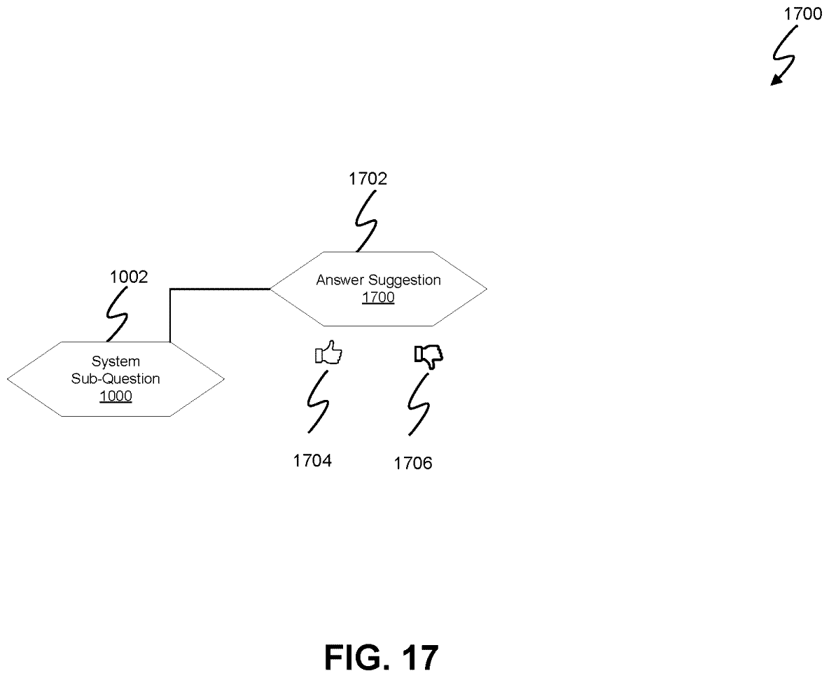

Referring to FIG. 17, an answer-suggestion 1700 (or the node 1702 thereof) is associated with a user-selectable “accept” option (represented by a “thumbs up” button 1704), which when selected, said answer-suggestion 1700 is accepted as an answer to the corresponding sub-question 1706. Referring to FIG. 9, the prompt generator 112, by executing the instructions, is configured to then feed this answer (i.e., the “accepted” answer-suggestion) as a new input re-prompt to the AI engine 114. Based on the resulting re-prompt output, the AI engine 114 updates the thought tree 110 accordingly. This updation includes generation of even more system sub-questions branching out from the corresponding sub-question, disabling the corresponding sub-question, modifying existing sub-questions, removing existing sub-questions, or a combination thereof.

Referring to FIG. 17, an answer-suggestion 1700 (or the node 1702 thereof) is associated with an exemplary user-selectable “dismiss” or a “reject” option (represented by a “thumbs down” button 1706), which when selected, said answer-suggestion 1700 is dismissed/rejected and the corresponding sub-question node 1002 is disabled. Referring to FIG. 9, this user interaction is then fed as a new input re-prompt to the AI engine 114 by the prompt generator 112. Based on the resulting re-prompt output, the AI engine 904 updates the thought tree 110 accordingly. This updation may include generation of other answer-suggestions, generation of even more system sub-questions, removal of existing system sub-questions, modification of existing system sub-questions, or a combination thereof. Alternatively, the AI engine 114 may choose to take no action other than the disablement of the corresponding sub-question 1000.

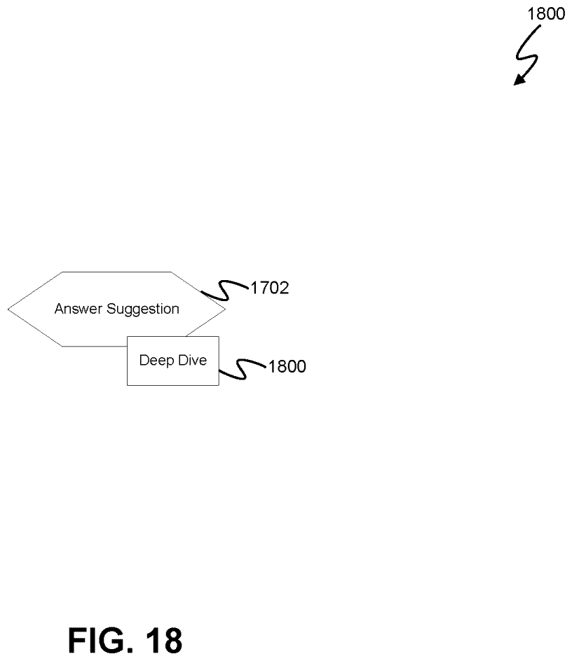

Referring to FIGS. 9 and 18, an answer-suggestion 1700 (or the node 1702 thereof) is associated with an exemplary user-selectable “deep-dive” button/link 1800, which when selected, the prompt generator 112, by executing instructions, re-prompts the AI engine 114 to retrieve from the contextual information database 116, a detailed explanation of said answer-suggestion 1700. Said detailed explanation is then is presented via the UI.

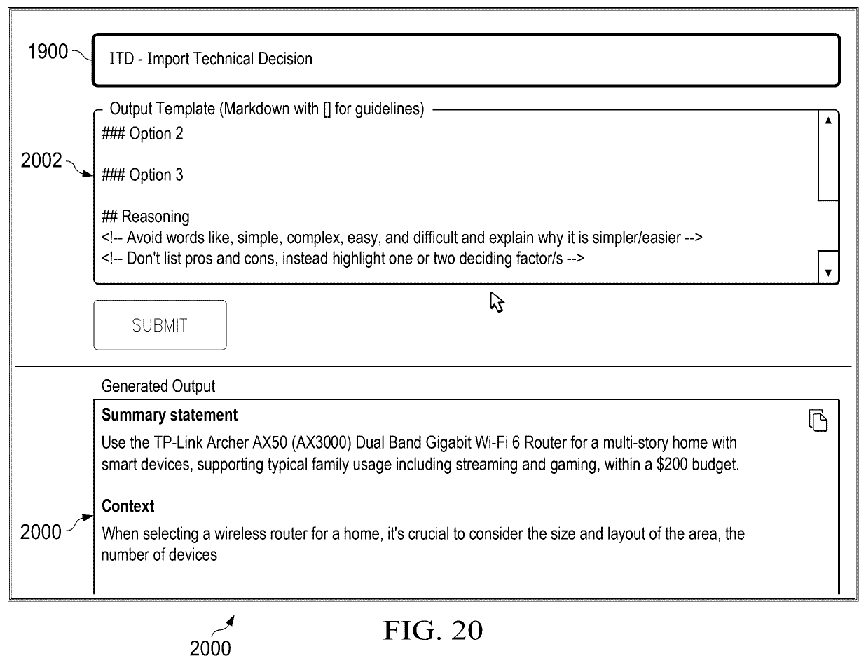

Referring to FIGS. 9, 19 and 20, after the user completes all interactions with the thought tree and it is updated accordingly, the user can finalize their input by selecting the “submit” button. Upon submission, the prompt generator 112 executes specific instructions to notify the AI engine 114 of the user's submission. In response, the AI engine 114 generates a preliminary thought tree textual output 2000, which serves as an answer to the origin question.

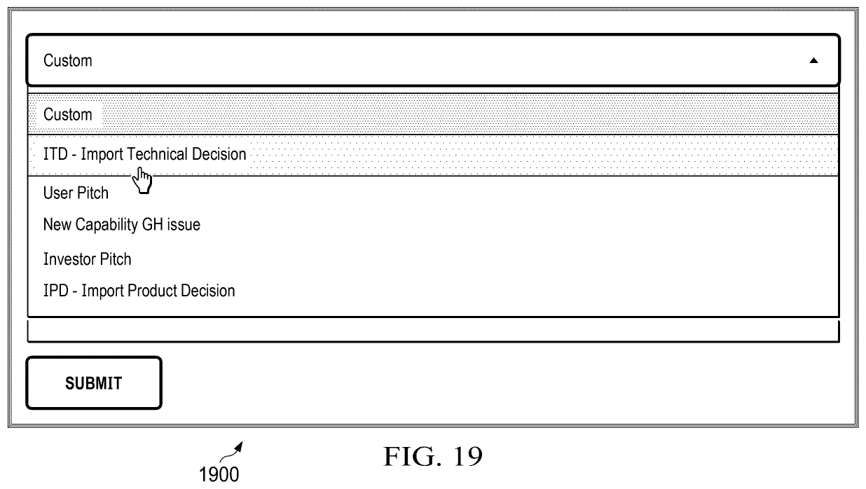

Still referring to FIGS. 9, 19 and 20, the processor, by executing instructions, is configured to allow the user to select, via the UI, a template from 1900 various options such as, technical decision, user pitch, text summary, new capability GitHub issue, investor pitch, product decision, etc., as seen in FIG. 19. Notably, said various templates are stored within the template repository. In one embodiment, the template repository is part of the AI engine 114. In one embodiment, the user is allowed to input his/her guidelines in order to generate a custom template that matches his/her needs.

The pseudo code representative of the generation of thought tree is as follows:

```
// Function to initialize the thought tree
function initializeThoughtTree( ) {
  // Create the root node of the tree
  rootNode = new Node(“Root”, null)
  // Set the current node to the root
  currentNode = rootNode
}
// Function to add a new node to the tree
function addNode(parentNode, content, nodeType) {
  // Create a new node with the given content and type
  newNode = new Node(content, nodeType)
  // Add the new node as a child of the parent node
  parentNode.addChild(newNode)
  return newNode
}
// Function to accept a node and expand the tree
function acceptNode(node) {
  // Unlock the node for further expansion
  node.unlock( )
  // Generate sub-questions or answers based on the node's content
  // AI-powered logic to generate context-specific questions
  subQuestions = AI.generateQuestions(node.content)
  // Add each sub-question as a child node
  subQuestions.forEach(question => {
    addNode(node, question, “Question”)
  })
}
// Function to reject a node and prune the tree
function rejectNode(node) {
  // Remove the node and its children from the tree
  node.parent.removeChild(node)
}
// Function to pin a node
function pinNode(node) {
  // Mark the node as important without changing the tree structure
  node.pin( )
}
// Function to request more sub-questions for a node
function requestMoreSubquestions(node) {
  // AI-powered logic to generate additional sub-questions
  moreSubQuestions = AI.generateMoreQuestions(node.content)
  // Add each new sub-question as a child node
  moreSubQuestions.forEach(question => {
    addNode(node, question, “Question”)
  })
}
// Function to request more answers for a node
function requestMoreAnswers(node) {
  // AI-powered logic to generate additional answers
  more Answers = AI.generateMoreAnswers(node.content)
  // Add each new answer as a child node
  more Answers.forEach(answer => {
    addNode(node, answer, “Answer”)
  })
}
// Function to generate output from the thought tree
function generateOutput(template, thoughtTree) {
  // AI-powered logic to transform the thought tree into the desired output
  outputText = AI.transformTreeToOutput(template, thoughtTree)
  return outputText
}
```

Upon selection, the processor, by executing instructions, prompts the AI engine 114 to present a templated thought tree output formatted according to the chosen template. This allows for the thought tree to be treated as a data structure that can used to derive different types of insights whereby, allowing said thought tree to serve as foundation for future work rather than being a final product. This involves data serialization that converts the tree structure into a format that can be easily stored and transmitted, such as JSON or XML. In one embodiment, the user can provide additional guidelines 2002 within a corresponding input section, which the processor relays to the AI engine 114. The AI engine 114 then modifies the chosen template based on these guidelines 2002 or creates a new template tailored to them. Notably, the processor leverages template engines, which are designed to combine templates with a data model to produce result documents. The template engines and user-centered design of the AI system & method ensure that the templates are not only adaptable to various scenarios but also intuitive and easy-to-use for the end user. Data serialization combined with AI text generation allows for the creation of diverse outputs from the same data structure thereby enhancing the AI system and method's versatility.

A use case for the AI system and method would be a product manager tasked with developing a new mobile app roadmap uses the thought tree to systematically break down the origin question, which is “develop a roadmap for a new mobile app.” Starting with the origin question, “Develop a roadmap for a new mobile app,” the tree generates sub-questions such as “Who is the target audience?” and “What are the key features of the app?” This prompts the manager to consider demographics, specific needs, primary and secondary functionalities, unique selling points, and monetization strategies. As the manager answers these questions, the AI generates further sub-questions to explore each aspect in greater depth, such as platform preferences and common pain points of the target audience. This dynamic, hierarchical questioning ensures a comprehensive and strategic approach, enabling the manager to develop a detailed and well-structured roadmap by addressing all critical factors systematically.

Another use case would be an engineer tasked with selecting a database for a new application, which would be origin question. To make an informed decision, the AI engine generates pertinent sub-questions such as: What are the data storage requirements, including volume, nature, and growth rate? What are the security considerations, like encryption, authentication, and compliance? What is the expected read/write workload and are real-time data processing capabilities needed? What are the scalability requirements for future growth? What is the budget for initial setup and ongoing costs? What level of support and community resources is available? What are the integration requirements with existing systems? What are the performance and reliability needs? Finally, what is the expertise of the engineering team? By addressing these questions, the engineer can systematically evaluate various database options, ensuring the selection of the most suitable solution for the application's specific needs and constraints.

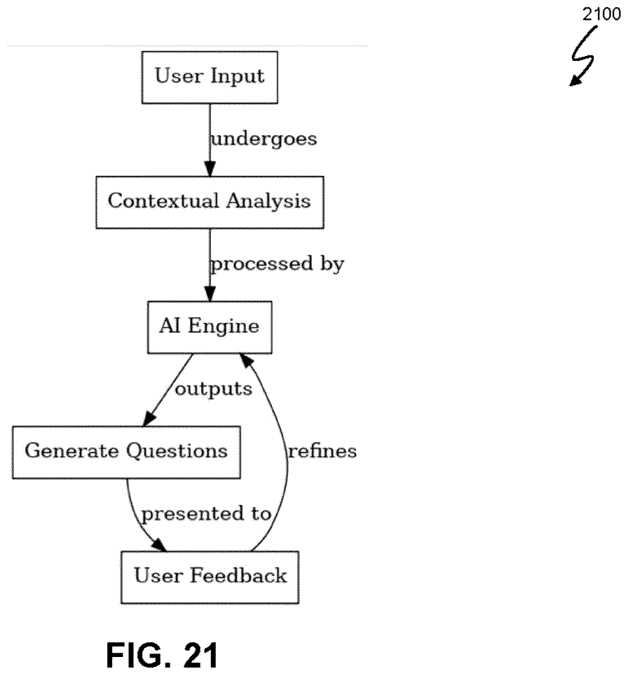

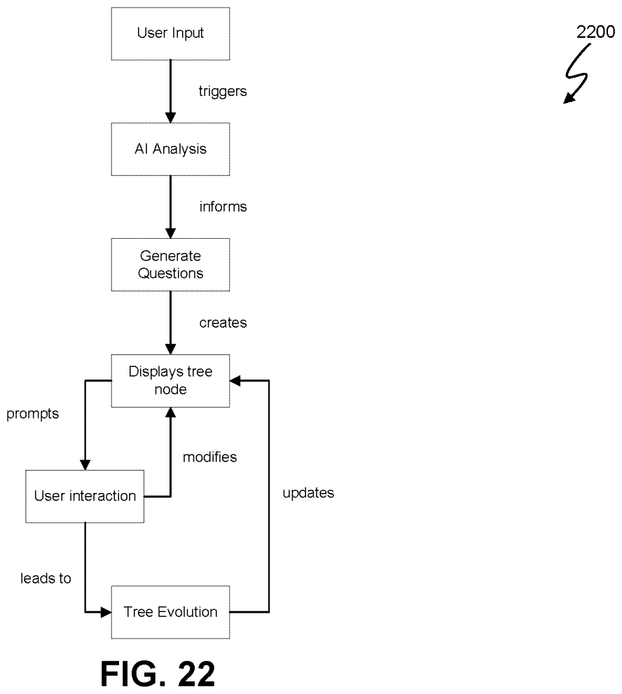

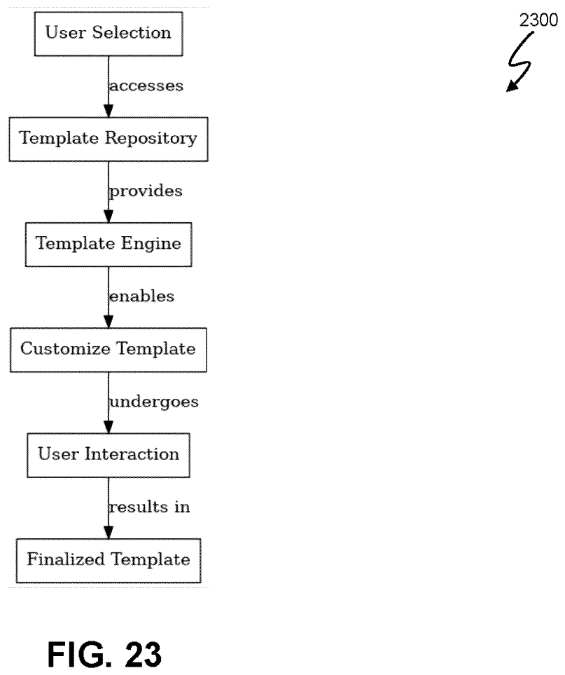

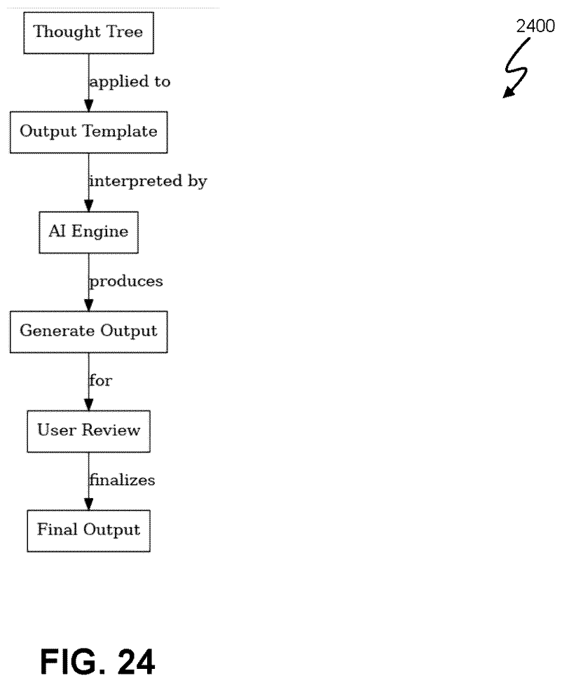

FIGS. 21-24 depict exemplary process flow diagrams for generating system sub-questions from an origin user question, interactive thought tree, custom template, and output thought tree for the chosen template, respectively, based on the artificial intelligence (AI)-driven process of FIG. 2.

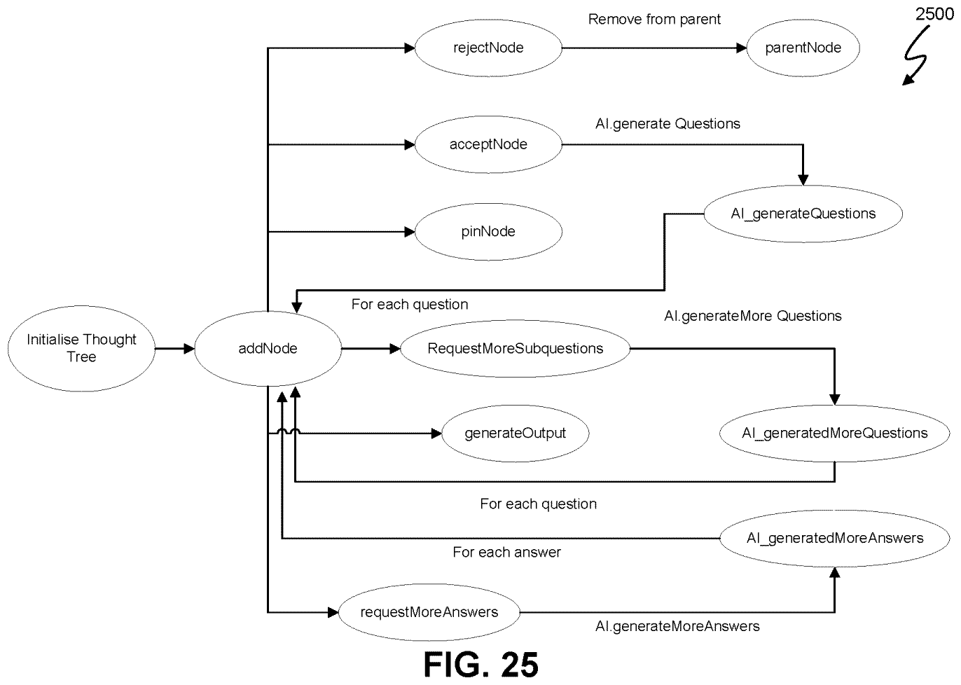

Referring to FIG. 25, the ‘initializeThoughtTree’ function sets up the initial state of the thought tree, establishing a foundational structure for further development. The ‘addNode’ function allows for the expansion of the tree by adding new nodes, representing new ideas or directions. When users agree with a node's content, they use the ‘acceptNode’ function, which leads to further expansion of the tree. Conversely, the ‘rejectNode’ function is used to prune the tree by removing unwanted nodes. The ‘pinNode’ function enables users to mark nodes as important, thereby guiding the thought process. Additionally, the ‘requestMoreSubquestions’ and ‘requestMoreAnswers’ functions empower users to expand the tree further on demand, exploring more detailed aspects of the topic. Finally, the ‘generateOutput’ function employs AI to convert the structured data of the tree into a coherent output based on a template.

Provided in the table below are exemplary prompts used by the AI-driven system for generating a dynamic and interactive thought tree of FIG. 1, as per the embodiments discussed in FIGS. 1-25 above.

| Purpose | Prompt |
|---|---|
| Generate | The user will provide you with some context, a problem statement, |
| subquestions | and <thoughtPathway> which is a sequence of thoughts that lead to the |
| to break | <problemStatement>. |
| down a | Your task is to generate a series of subquestions that will guide the |
| problem | problem-solving process and help arrive at the answer to the problem. |
| | First, study the context and thoughtPathway, then identify the key |
| | elements and constraints in the problem statement. Write these down inside |
| | ′keypoints′. |
| | Next, based on the context and problem statement, generate a series |
| | of subquestions that break down the problem into smaller, more manageable |
| | parts. Each subquestion should address a specific aspect of the problem and |
| | build towards the overall solution. Aim to generate 3 subquestions. |
| | Write the subquestions inside ′subquestions′ array, with each |
| | subquestion a string in the array. |
| | After the subquestions, provide a brief justification inside |
| | ′justification′ explaining how answering these subquestions will help solve |
| | the overall problem. |
| | Always call the handleSubquestions tool with your response. >Make sure to |
| | carefully analyze the problem statement and generate subquestions that |
| | comprehensively cover the key aspects needed to solve it. The quality and |
| | relevance of the subquestions are crucial. |
| Generate | The user will provide you with some context, , and a problem statement or |
| answers or | question related to the context. Your task is to determine if the information is |
| follow-up | adequate to come up with some plausible answers. If you decide that there |
| questions | isn't enough information then generate upto 3 ″specific″ questions you would |
| | like answers to, in order to proceed. Avoid asking yes or no questions like |
| | ″Can″, ″Should″, etc unless requested by the user. If you can come up with |
| | some answers generate upto 3 different answers. First generate the most |
| | plausible answer, then generate another likely answer. And finally think out |
| | of the box and come up with an innovative answer. |
| | You must format your output as a JSON value that will succesfully |
| | be parsed by a json parser. Here are some examples: |
| | {″type″: ″answers″, ″answers″: [″answer1″, ″answer2″, ″answer3″]} |
| | {″type″: ″questions″: ″questions″: [″question1″, ″question2″, |
| | ″question3″], ″noAnswerReason″: ″This is the reason why I couldn't come up |
| | with an answer″} |
| Generate | The user will provide you with some context, a problem statement or |
| only answers | question, the <thoughtPathway> leading to the question, and |
| | <inquiryResults>. Use your expertise and the information in the context, |
| | thoughtPathway and inquiryResults to come up with upto 3 different answers |
| | to the question. Give specific and direct answers. You must output a JSON as |
| | follows: |
| | <example1> |
| | {″type″: ″answers″, ″answers″: [″answer1″, ″answer2″, ″answer3″]} |
| | </example1> |
| Generate only | The user will provide you with some context, <thoughtPathway>, |
| follow-up | and a problem statement or question related to the context. Use your expertise |
| questions | and the information in the context, thoughtPathway and inquiryResults to |
| | come up with upto 3 ″specific″ questions you would like answers to, in order |
| | to get adequate information to answer the given problem statement or |
| | question. Avoid asking yes or no questions like ″Can″, ″Should″, etc unless |
| | requested by the user. You must format your output as a JSON value that will |
| | succesfully be parsed by a json parser. You must output a JSON as follows: |
| | {″type″: ″questions″: ″questions″: [″question1″, ″question2″, ″question3″]} |
| Check if | The user will provide you with some context, <thoughtPathway>, |
| up-to-date | and a question related to the context. You need to determine whether to |
| information | answer that question, you need up-to-date information from the internet or |
| is required | not |
| | ## Factors to consider before answering the question |
| | - If you need up-to-date information from websites or the internet |
| | would be required to provide a better answer to the question, |
| | isUpToDateInfoRequired should be true. You should use up-to-date |
| | information to answer questions whose answers would be evolving over time. |
| | - Otherwise, if your knowledge as an AI language model is enough |
| | to answer the question, isUpToDateInfoRequired should be false |
| | ## Output |
| | You must format your output as a JSON value that will successfully |
| | be parsed by a json parser. Here are some examples |
| | { |
| | ″reasoning″: string, // a very brief, one line explanation of why you |
| | need or don't need up-to-date information |
| | ″isUpToDateInfoRequired″: boolean, // true if you need the up-to- |
| | date information, false otherwise |
| | } |
| Convert bullet | The user will provide you with bullet point or markdown or a |
| points/ | combination, that represent a tree or list. Your task is parse the text and |
| markdown to a | convert it into tree of nodes |
| tree structure | Follow these guidelines: |
| | 1) Start your tree with a root node with the text ″root node″. |
| | 2) Add the first level of points from the user markdown as children of |
| | the ″root node″. |
| | Here is an example: |
| | <example> { ... }</example> |
| | 3) Execute the submitTree(..) tool/function and pass it the tree you |
| | generated in the previous step. You do not need to respond to the user with |
| | the tree. |
| | The user will provide you with bullet point or markdown or a |
| | combination, that represent a tree or list. Your task is parse the text and |
| | convert it into tree of nodes |
| Generate | You will be provided with the following: |
| output text | - a <ProblemStatement> |
| fitting a | - some <context> you need to know about to solve the problem |
| template | - <inquiryResults> containing information found so far. Statements |
| | starting with ′Q.′ and ′T.′ are Questions, ′A.′ are Answers. |
| | - a <template> that shows how the solution should be presented. |
| | Anything in square brackets [ ] should be considered guidelines and not |
| | included in the output. |
| | You will do the following: |
| | 1) Study the <problemStatement>, <context>, and <inquiryResults>. |
| | Pay attention to the indentation in the inquiryResults to associate questions |
| | with their corresponding answers and subquestions. |
| | 2) Use only the information in the <inquiryResult>, <context>, |
| | <problemStatement> to generate a text that fits the template and guidelines. |
| | Generate only the parts you have enough information for, and for the rest add |
| | ′[Not enough information]′. |
| | 3) Double check that the output contains only information from the |
| | inquiryResults, context, and problemStatement. Rephrase by removing any |
| | external information that is not provided in the inquiryResults, context, and |
| | problemStatement. |
| | NOTE: You must not use any external information to generate the |
| | output. Only use the information provided in the inquiryResults, context, and |
| | problemStatement. |
| Break down | You are an adept at breaking problems down to simplify them. You |
| a problem | have a curious mind that approaches problems by breaking them down into a |
| into a tree | tree of specific and to the point questions. |
| of questions | The user will give you some <context> and a <problemStatement>. |
| | You should express how you will break this problem down and solve it, as a |
| | tree of questions. Write all points as questions, and as clear specific |
| | questions. Unless requested by the user, avoid asking yes or no questions like |
| | ″Can″, ″Should″, etc. Do not respond to the user directly with any text. |
| | Instead invoke the ′processTree(tree: object)′ function/tool. |
| | ## Important Constraints |
| | - At the first level of children, you must only generate a max of 5 |
| | questions. |
| | - At the first level of children, you will pick the most important & |
| | high-level questions that will help solve the problem. |
| | - Questions that you ask must not be questions that you already have |
| | the answer to in the context or problem statement. |
| Break down | You are an adept at breaking problems down to simplify them. You |
| a problem | have a curious mind that approaches problems by breaking them down into a |
| into three | tree of specific and to the point questions. |
| different tree | The user will give you some <context> and a <problemStatement>. |
| approaches | You should express three different approaches of how you should break |
| | down the problem and solve it, as a tree of questions. Write all points as |
| | questions, and as clear specific questions. Unless requested by the user, avoid |
| | asking yes or no questions like ″Can″, ″Should″, etc. You should output a |
| | JSON in the following format: |
| | { ... } |
| | ## Important Constraints |
| | - For each approach, at the first level of children, you must only |
| | generate a max of 5 questions. |
| | - For each approach, at the first level of children, you will pick the |
| | most important & high-level questions that will help solve the problem. |
| | - Questions that you ask must not be questions that you already have |
| | the answer to in the context or problem statement. |
| | - Note that the main problem statement is the same for all three |
| | approaches. |
| Generate a | ## Role |
| title for a | You are an expert at naming things. |
| problem | ## Input |
| statement | You will be provided with a problem statement, context about the |
| | problem statement. |
| | ## Instructions |
| | (1) You are to generate a title for the problem that we're trying to |
| | solve in 7-10 words. |
| | (2) The title should focus on the most important aspect of the |
| | problem. |
| | (3) If the context about the problem statement is not enough, use only |
| | the problem statement. If neither are enough for you to generate a title, the |
| | generated title should be ″Untitled Tree″. |
| | (4) The title should be plain text, not a markdown. |
| Generate a | Create a detailed markdown template for presenting solution to a |
| markdown | given problem statement. |
| template for | The template should include clear sections and formatting to help the |
| presenting | user organize their solution effectively. |
| a solution | Steps to create the markdown template: |
| | 1. Understand the Problem Statement: |
| | - Break down the problem statement into its main components: goal, |
| | requirements, constraints, solution approaches and so on. |
| | 2. Identify Key Sections: |
| | - Determine the main sections to organize the solution. Common |
| | sections include: |
| | - Introduction |
| | - Problem Definition |
| | - Solution Approach |
| | - Implementation |
| | - Results |
| | - Conclusion |
| | 3. Define Subsections: |
| | - For each main section, identify necessary subsections. For |
| | example, within the ″Solution Approach″ section, include subsections for |
| | different methods or steps involved in the solution. |
| | 4. Create the Structure: |
| | - Use markdown syntax to outline the structure. Include headings, |
| | subheadings, and placeholder text to guide the user. |
| | 5. Add Formatting: |
| | - Enhance readability and organization using markdown formatting |
| | such as bold, italics, bullet points, and code blocks. |
| | Output the final template between ‘‘‘md ‘‘‘ tags. |
| | ## Note: |
| | 1. You are not going to provide a solution. Your job is to provide a |
| | template in which a solution should be presented. |
| | 2. Your template should not include content or problem definition, |
| | that is already known. |
| | 3. Your template should not include references, bibliography, |
| | appendices. |
| Summarize a | You are an expert at summarizing information. |
| tree of | ## Input |
| Q&A | The user will provide you with bullet points that represent a tree. The |
| | first point starting with ′T′ is the main question or problem statement. The |
| | points under the main question starting with ′T′ or ′Q′ are subquestions and |
| | points starting with ′A′ are answers to the questions. Each question can have |
| | multiple subquestions and / or answers. |
| | ## Task |
| | Your task is to generate a summary of the tree to answer the main |
| | question or problem statement using only the information provided in the |
| | tree. |
| | ## Critical Instructions: |
| | - You must not add any new information that is not present in the tree |
| | - Do not restate the main question in your output |
| | - Do not make up your own points in the summary. Only use the |
| | information provided in the tree. |
| | ## Output |
| | The summary should be in markdown format. Avoid using # or ## |
| | for titles. |
| Generate an | ## Role |
| answer to a | You are an expert at thinking about complex questions and |
| main question, | generating answers to them. |
| considering | ## Input |
| context and | The user will provide you with a main question, the context for the |
| sub-questions | main question and some sub-questions that you should keep in mind. |
| | ## Task |
| | Your task is to generate an answer to the main questions while |
| | keeping the context, the sub-questions and the answers to the sub-questions in |
| | mind. |
| | ## Output |
| | You should only output an answer to the main question in a |
| | markdown format. Do not use headings greater than h3 in your answer. |

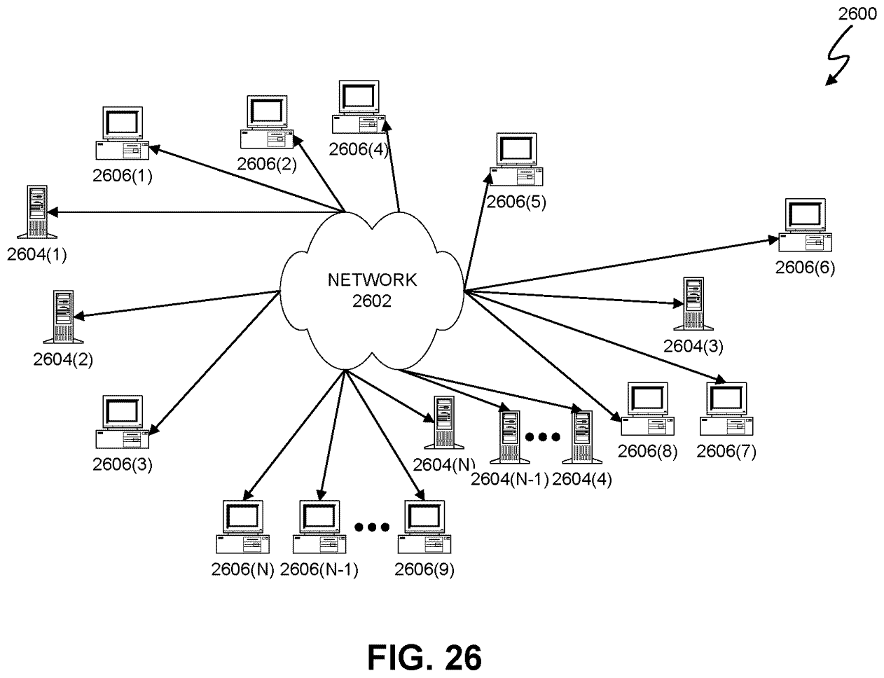

FIG. 26 is a block diagram illustrating a network environment in which a mixed content delivery system 100 and process 200 may be practiced. Network 2602 (e.g. a private wide area network (WAN) or the Internet) includes several networked server computer systems 2604(1)-(N) that are accessible by client computer systems 2606(1)-(N), where N is the number of server computer systems connected to the network. Communication between client computer systems 2606(1)-(N) and server computer systems 2604(1)-(N) typically occurs over a network, such as a public switched telephone network over asynchronous digital subscriber line (ADSL) telephone lines or high-bandwidth trunks, for example, communications channels providing T1 or OC3 service. Client computer systems 2606(1)-(N) typically access server computer systems 2604(1)-(N) through a service provider, such as an internet service provider (“ISP”) by executing application-specific software, commonly referred to as a browser, on one of client computer systems 2606(1)-(N).

Client computer systems 2606(1)-(N) and/or server computer systems 2604(1)-(N) are specialized computers programmed to improve conventional computer systems to implement and utilize the mixed content delivery system 100 and process 200. The type of computer system that can be specially programmed to implement and utilize the mixed content delivery system 100 and process 200 includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the mixed content delivery system 100 and process 200 can be implemented using code stored in a tangible, non-transient computer-readable medium and executed by one or more processors. In at least one embodiment, the mixed content delivery system 100 and process 200 can be implemented completely in hardware using, for example, logic circuits and other circuits including field programmable gate arrays.

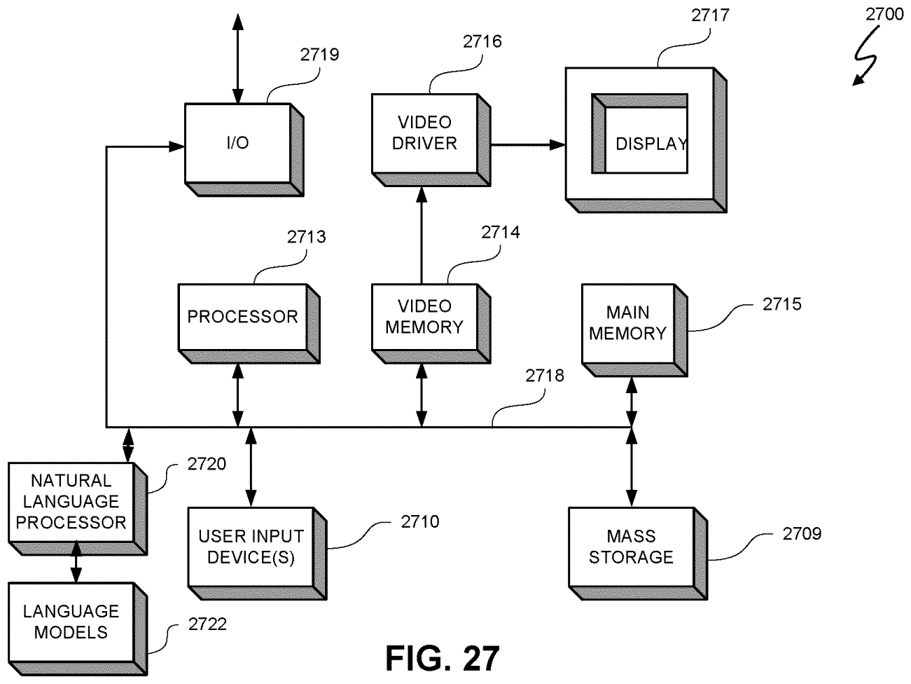

Embodiments of the mixed content delivery system 100 and process 200 can be implemented on a computer system such as a special-purpose, special-programmed computer 2700 illustrated in FIG. 27. The input user device(s) 2710, such as a keyboard and/or mouse, are coupled to a bi-directional system bus 2718. The input user device(s) 2710 are for introducing user input to the computer system and communicating that user input to processor 2713. The computer system of FIG. 27 generally also includes a non-transitory video memory 2714, non-transitory main memory 2715, and non-transitory mass storage 2709, all coupled to bi-directional system bus 2718 along with input user device(s) 2710 and processor 2713. The mass storage 2709 may include fixed and removable media, such as a hard drive, one or more CDs or DVDs, solid state memory including flash memory, and other available mass storage technology. Bus 2718 may contain, for example, 32 of 64 address lines for addressing video memory 2714 or main memory 2715. The system bus 2718 also includes, for example, an n-bit data bus for transferring DATA between and among the components, such as CPU 2709, main memory 2715, video memory 2714, and mass storage 2709, where “n” is, for example, 32 or 64. Alternatively, multiplex data/address lines may be used instead of separate data and address lines.

I/O device(s) 2719 may provide connections to peripheral devices, such as a printer, and may also provide a direct connection to a remote server computer systems via a telephone link or to the Internet via an ISP. I/O device(s) 2719 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 2709, into main memory 2715 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 2713, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 2715 is includes of dynamic random access memory (DRAM). Video memory 2714 is a dual-ported video random access memory. One port of the video memory 2714 is coupled to the video amplifier 2716. The video amplifier 2716 is used to drive the display 2717. Video amplifier 2716 is well-known in the art and may be implemented by any suitable means. This circuitry converts pixel DATA stored in video memory 2714 to a raster signal suitable for use by display 2717. Display 2717 is a type of monitor suitable for displaying graphic images.

The computer system described above is for purposes of example only. The mixed content delivery system 100 and process 200 may be implemented in any type of computer system or programming or processing environment. It is contemplated that the mixed content delivery system 100 and process 200 might be run on a stand-alone computer system, such as the one described above. The mixed content delivery system 100 and process 200 might also be run from a server computer system that a plurality of client computer systems can access interconnected over an intranet network. Finally, the mixed content delivery system 100 and process 200 may be run from a server computer system that is accessible to clients over the Internet.

The aforementioned embodiments are able to be implemented, for example, using a machine-readable medium or article which is able to store an instruction or a set of instructions that, if executed by a machine, cause the machine to perform a method and/or operations described herein. Such machine can include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions can include any suitable type of code, for example, source code, compiled code, interpreted code, executable code, static code, dynamic code, or the like, and is able to be implemented using any suitable high-level, low-level, object-oriented, functional-programming, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, can be combined with, or is able to be utilized in combination with, one or more other functions, operations, components and/or features described herein with reference to one or more other embodiments, or vice versa.

Embodiments and examples are described above, and those skilled in the art will be able to make various modifications to the described embodiments and examples without departing from the scope of the embodiments and examples.

Although the processes illustrated and described herein include series of steps, it will be appreciated that the different embodiments of the present disclosure are not limited by the illustrated ordering of steps. Some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

What is claimed is:

1. An artificial intelligence (AI)-driven method for generating a thought tree comprising:
a) via a user interface (UI), receiving a user input comprising an origin user question;
b) prompting an AI engine to decompose the origin question into a hierarchical set of multiple system sub-questions;
c) via the UI, presenting the system sub-questions within the nodes of a branching tree structure, the system sub-questions categorized into intermediary and ultimate system sub-questions, an intermediary system sub-question branching out from either the origin question or another preceding intermediary system sub-question with one or more subsequent sub-questions branching out therefrom, an ultimate system sub-question branching out either from the origin question or a preceding intermediary system sub-question with no succeeding sub-question branching out therefrom, the origin question along with the sub-questions collectively referred to as an interactive, dynamic thought tree hereinafter;
d) capturing a user interaction with a sub-question;
e) reprompting the AI engine with the user interaction;
f) dynamically updating the thought tree based on the response from AI engine with respect to the reprompt;
g) looping back to step (d) with each user interaction with the updated thought tree as a new input and iteratively repeating steps (d) through (f) until user submission; and
h) generating a preliminary thought tree output comprising an output text in response to the user submission, the output text serving as an answer to the origin question.

2. The method of claim 1, wherein the user input further comprises context information.

3. The method of claim 1, wherein a user interaction with an ultimate system sub-question comprises one of: accepting the sub-question, answering the sub-question, dismissing the sub-question, editing the sub-question and providing an answer thereto, and replacing the sub-question with another sub-question and providing an answer thereto.

4. The method of claim 1, wherein a user interaction with an intermediary system sub-question comprises one of: dismissing said sub-question, editing said sub-question, and replacing said sub-question with a new sub-question; interacting with an intermediary system sub-question resulting in affecting the ultimate questions branching out therefrom accordingly.

5. The method of claim 1, wherein updating the thought tree involves: automatically adding additional system sub-questions, automatically removing the existing system sub-questions, automatically changing the existing system sub-questions, disabling a system sub-question upon receiving an answer thereto, or a combination thereof.

6. The method of claim 1 further comprising adding, via the UI, an ultimate user sub-question to the thought tree, an ultimate user sub-question branching out from either the origin question or another sub-question with no sub-question branching out therefrom.

7. The method of claim 1 further comprising adding, via the UI, an intermediary user sub-question to the thought tree; an intermediary user sub-question branching out from either the origin question, a preceding intermediary system sub-question, or another preceding intermediary user sub-question.

8. The method of claim 1 further comprises presenting a templated thought tree output comprising the output text formatted and presented in a user-selected template format.

9. The method of claim 8 further comprising receiving additional guidelines to refine the template structure.

10. The method of claim 1 further comprising presenting an answer-suggestion branching out from a corresponding sub-question; the interactions with said answer-suggestions, or the node thereof, via the UI, including acceptance and rejection thereof.

11. The method of claim 10, wherein an answer-suggestion, or the node thereof, is associated with an exemplary “deep dive” UI button, which when selected, an explanation of the answer-suggestion is outputted.

12. The method of claim 1, wherein a sub-question, or the node thereof, is associated with an exemplary “generate answer” UI button, which when selected, one or more answer-suggestions are outputted.

13. The method of claim 1, wherein a sub-question, or the node thereof, is associated with an exemplary “pin” UI button, which when selected, said sub-question is exempt from changing in the event of the thought tree updation.

14. The method of claim 1, wherein a sub-question, or the node thereof, is associated with an exemplary “generate additional sub-questions” UI button, which when selected, a new system sub-question is branched out therefrom.

15. The method of claim 1 further comprising:
receiving a nudge input with respect to a system sub-question; and
prompting the AI engine to process the nudge input, resulting in the system sub-question being modified in accordance with the nudge input.

16. The method of claim 1 further comprising refraining from generating system sub-question beyond a predetermined threshold number.

17. The method of claim 1 wherein, the thought tree is generated and updated by the AI engine.

18. An AI-driven system for generating a dynamic and interactive thought tree comprising:
a memory storing instructions;
one or more processors configured to execute the instructions to:
receive, via the UI, a user input comprising an origin user question;
prompt an AI engine to decompose the origin question into a hierarchical set of multiple system sub-questions;
present, via the UI, the system sub-questions within nodes of a branching tree structure, the system sub-questions categorized into intermediary and ultimate system sub-questions, an intermediary system sub-question branching out from either the origin question or another preceding intermediary system sub-question with one or more subsequent sub-questions branching out therefrom, an ultimate system sub-question branching out either from the origin question or a preceding intermediary system sub-question with no succeeding sub-question branching out therefrom, the origin question along with the sub-questions collectively referred to as an interactive, dynamic thought tree;
capture a user interaction with a sub-question;
reprompt the AI engine with the user interaction;
present, via the UI, dynamically updated the thought tree based on the response from AI engine with respect to the re-prompt;
iteratively repeat the capturing of each user interaction, reprompting, and presenting the updated the thought tree until user submission; and
generate a preliminary thought tree output comprising output text in response to the user submission, the output text serving as an answer to the origin question.

19. The system of claim 18, wherein the user input further comprises context information.

20. The system of claim 18, wherein a user interaction with an ultimate system sub-question comprises one of: accepting the sub-question, answering the sub-question, dismissing the sub-question, editing the sub-question and providing an answer thereto, and replacing the sub-question with another sub-question and providing an answer thereto.

21. The system of claim 18, wherein a user interaction with an intermediary system sub-question comprises one of: dismissing said sub-question, editing said sub-question, and replacing said sub-question with a new sub-question; interacting with an intermediary system sub-question resulting in affecting the ultimate questions branching out therefrom accordingly.

22. The system of claim 18, wherein updating the thought tree involves: automatically adding additional system sub-questions, automatically removing the existing system sub-questions, automatically changing the existing system sub-questions, disabling a system sub-question upon receiving an answer thereto, or a combination thereof.

23. The system of claim 18, wherein the one or more processors are further configured to execute the instructions to, via the UI, add an ultimate user sub-question to the thought tree, an ultimate user sub-question branching out from either the origin question or another sub-question.

24. The system of claim 18, wherein the one or more processors are further configured to execute the instructions to, via the UI, add an intermediary user sub-question to the thought tree; an intermediary user sub-question branching out from either the origin question, a preceding intermediary system sub-question, or another preceding intermediary user sub-question.

25. The system of claim 18, wherein the one or more processors are further configured to execute the instructions to present a templated thought tree output comprising the output text formatted and presented in a user-selected template format.

26. The system of claim 25, wherein the one or more processors are further configured to execute the instructions to receive additional guidelines to refine the template structure.

27. The system of claim 18, wherein the one or more processors are further configured to execute the instructions to present an answer-suggestion branching out from a corresponding sub-question; the interactions with said answer-suggestions, or the node thereof, via the UI, including acceptance and rejection thereof.

28. The system of claim 27, wherein an answer-suggestion, or the node thereof, is associated with an exemplary “deep dive” UI button, which when selected, an explanation of the answer-suggestion is outputted.

29. The system of claim 18, wherein a sub-question, or the node thereof, is associated with an exemplary “generate answer” UI button, which when selected, one or more answer-suggestions are outputted.

30. The system of claim 18, wherein a sub-question, or the node thereof, is associated with an exemplary “pin” UI button, which when selected, said sub-question is exempt from changing in the event of the thought tree updation.

31. The system of claim 18, wherein a sub-question, or the node thereof, is associated with an exemplary “generate additional sub-questions” UI button, which when selected, a new system sub-question is branched out therefrom.

32. The system of claim 18, wherein the one or more processors are further configured to execute the instructions to:
receive a nudge input with respect to a system sub-question; and
prompt the AI engine to process the nudge input, resulting in the system sub-question being modified in accordance with the nudge input.

33. The system of claim 18, wherein the one or more processors are further configured to execute the instructions to refrain from generating system sub-questions beyond a predetermined threshold number.

34. The system of claim 18 wherein, the thought tree is generated and updated by the AI engine.
